(19) United States
(12) Patent Application Publication
(10) Pub. No.: US 2016/0233755 A1
(43) Pub. Date: Aug. 11, 2016

(54) WHEELED POWER PLANT WITH RENEWABLE ENERGY

(71) Applicant: Hami BAYRAKDAR, Istanbul (TR)

(72) Inventor: Hami BAYRAKDAR, Istanbul (TR)

(21) Appl. No.: 15/024,746

(22) PCT Filed: Sep. 24, 2014
(86) PCT No.: PCT/TR2014/000348

§ 371 Date: Mar. 24, 2016

(30) Foreign Application Priority Data
Sep. 24, 2013 (TR) 2013/11206

(51) Int. Cl. H02K 47/00; B60C 99/00; B60B 19/00; H02K 41/06

(52) U.S. Cl. CPC H02K 47/00; H02K 41/06; B60C 99/003; B60C 99/00; B60B 19/00; Y10S 74/09; H02K 53/00

(57) ABSTRACT

The invention relates to a novel type of wheeled power plant with renewable energy wherein a plurality of the wheels generating electrical energy more than the electrical energy required for rotation of at least one wheel that generate energy are assembled together within a system and control, and generate energy in the order of MW by moving the wheels at desired speed by triggering also the electric generators installed on the ground on which the wheels will travel, wherein generated electricity is provided with the required technical specifications and values and transferred to an interconnected system.

### TECHNICAL FIELD

Embodiments of the present disclosure relate to wheeled power plant with renewable energy providing the generation of electrical energy of high efficiency from the electricity generating wheels brought together within the frame of a system and control and from the electricity generators placed on the ground over which the mentioned electricity generating wheels travel and providing the transfer of the electricity generated to the interconnected system for use, after it is brought to the required values.

### PRIOR ART

The major problems experienced in the world concerning electrical energy are that the economic life of the power plants installed so far has expired; that the nuclear plants lead to discontent and the demand for them diminish, while the world requires more energy every day as a result of the rapid technological advancements. Continuous increase in both investment and production costs of the fossil fuels and nuclear energy and shale gas, which induce environmental catastrophes, as well as the current commissioning studies for the electrical vehicles employing charging method gradually increases the problems of the world concerning electrical energy.

Power plants with various properties are established in order to generate the electrical energy required by the people. Properties and disadvantages of such power plants in the prior art are as follows;
Coal operated power plants: Although a cheap method for generating electrical energy, the coal used as fuel in power generation processes pollutes the nature, releases carbon dioxide to the environment at hazardous levels and leads to foreign-source dependency in countries with no coal reserve.
Natural gas operated power plants: This is not only an expensive power generation method but also leads to foreign-source dependency as many countries lack natural gas reserves.
Hydroelectric power plants: Although the most suitable plant for nature, these plants require abundant tributary sources and significance of water reserves is high.
Nuclear power plants: Although capable of meeting majority of the energy sources of the countries, nuclear power plants are very hazardous and detrimental for the nature. They are dangerous, environmentally hazardous and very expensive plants. Moreover, installation of nuclear power plants requires very long time and a highly expensive investment amount.
Power plants running on petroleum products: The main problems in the power plants running on various petroleum products are the environmental pollution, carbon dioxide emission to the environment at hazardous levels and foreign-source dependency.
Solar panel power plants: Although a clean energy system, installation of solar panels requires an expensive investment and operation of the plant is dependent on the intensity and duration of the sun rays.
Wind power plants: Although a clean energy system, installation of wind turbines requires an expensive investment and efficient operation of the plant is dependent on the limited durations where the wind power is effective, thus efficiency is low.
Shale gas operated power plants: The shale gas extraction technology used for extracting the shale gas used in these power plants is very expensive. Moreover, only several countries have shale gas reserves and the damages inflicted on the nature by the shale gas still remain unknown.

The patent application No. 2010/08109, with the classification class F24J 2/12, relates to a solar power plant. The solar power plant of the invention is designed to generate thermal energy at high temperatures by means of intensified sun rays; thus obtained high-temperature thermal energy has applications in many fields in the industry. However, installation of this plant requires an expensive investment and operation of the plant is dependent on the intensity and duration of the sun rays.

The patent application No. 2005/04542, with the classification classes F03B 13/18 and F03B 7/00, relates to a power plant that generate electrical energy by controlling the wave energy. Said invention is characterized by the floats installed on the sea surface; arms that activate the suction pumps through reciprocating motion as each float moves up and down; the suction pumps raising the sea water; safety pipes that transfer the pressurized water generated by the suction pumps to the top side of the cabinet; the water cabinet receiving the pressurized water from the safety pipes; the cabinet shaft where the motion of the sea water flowing upon with movement of the water cabinet is converted into rotational motion; hydraulic pump group mechanisms where the torque of the cabinet shaft is converted into high-pressure fluid, pressure regulators where the high-pressure hydraulic fluid pressure generated by the hydraulic pump group is regulated; and collectors connected to said pressure regulators; and hydraulic motor driven generator groups that convert the energy of the high-pressure fluid coming from these collectors into electrical energy.

In conclusion; developments are made in regard to the importance of the renewable energy sources and the technical studies on these subjects due to aforementioned disadvantages, increase in the world economy and population, need for more electrical energy and diminishing reserves, therefore new configurations that will eliminate aforementioned disadvantages and provide solution to the existing systems are needed.

### Objective of the Invention

The present invention relates to a novel type of wheeled power plant with renewable energy which meets the aforementioned requirements, eliminates all disadvantages and brings some additional advantages, wherein a plurality of the wheels generating electrical energy more than the electrical energy required for rotation of at least one wheel that generate energy are assembled together within a system and control, and can transfer the energy to be produced in the order of MW by moving said wheels at desired speed by triggering also the electric generators installed on the ground on which said wheels will travel to an interconnected system by providing said energy to be produced with required technical specifications and values and transferred that.

The primary objective of the invention is to develop a novel type of wheeled power plant with renewable energy that will generate electricity in the order of MW-GW with low cost by assembling and rotating a plurality of identical wheels generating electricity within a certain arrangement and system that will generate electricity many times more than the electrical energy required for rotation of the wheel, and to transfer the same to the interconnected system after providing thereof with the desired technical values and specifications rather than using electricity generating wheels only for solving the electricity problem of the electrical vehicles.

Another objective of the invention is to ensure that generation of the electrical energy required by the people is performed with much lower costs.

An objective of the invention is to prevent use of foreign sources such as petroleum products, natural gas, etc. in electric generation, thus reduce foreign-dependency in energy.

An objective of the invention is to reduce the energy costs in manufacturing industry by bringing down the electricity generation costs.

An objective of the invention is to prevent the damages inflicted by other power plants to the nature.

In order to fulfill aforementioned objectives, the reason for the wheel to travel from point H, where it touches the ground, to the point B, thus to trigger the electrical generators in triggering the magnetic energy by the kinetic energy generated at the rotating wheel is the deformation of 1-2 cm that occurs in the tire base, wherein the most significant factor is the HB Thrust/Deformation Force that occurs with the weight of the wheel+the weight of the vehicle. The HB Thrust/Deformation force triggers the drive shaft and gear group to which the natural magnet rotor is connected, and enables the rotor to rotate around the generator wound stationary stator, also called as the brushless motor, with high speed. A large amount of electrical energy is obtained through well-calculation of the magnetic power of the rotor, the revolutions per minute of the rotor and coil windings of the generator wound stator. In this manner, an electricity-generating wheel that generates electrical energy at high values is obtained with at least one generator wound dual hub motor alternator installed between the wheel tire base and detachable rim, or outside thereof. The electricity-generating wheels can be manufactured around the stator or with rotor stationary stator active systems with natural magnet rotors in wheel formation or in wheel formation with other methods. The calculations are made in such manner to generate more electricity than the electrical energy required for rotation of these electricity-generating wheels. The surplus electrical energy generated by bringing together a plurality of at least one electricity-generating wheel within an operating system can be transferred to the interconnected system after being provided with the desired technical specifications and values. In this manner, a novel electricity generation method with renewable energy is obtained.

### FIGURES TO FACILITATE UNDERSTANDING OF THE INVENTION

FIG. 1 is the schematic view illustrating the deformation caused by HB Thrust/Deformation Force that occurs due to rotational motion in the wheel and wheel load.

FIG. 2 is the views of the round wheel cross-section of the electricity-generating wheels.

FIG. 3 is the cross-sectional view of the electricity-generating wheel comprising alternators obtained by synchronized operation of two generator wound hub motors with a single drive shaft.

FIG. 4 is the cross-sectional view of the electricity-generating wheel comprising roller rotor with circular motion system thereon in which generator wound stator is fixedly installed between the tire base and deepened detachable rim in circular position.

FIG. 5 is the view illustrating the rotating wheel the rim of which is designed as rotor, the wheel generating electricity by rotating around the generator wound stator fixed to the gooseneck bearing foot and the wheeled power plant comprising the same.

FIG. 6 is the view illustrating the piezo-crystal electricity-generating wheel comprising piezo crystals installed within the tire base or between the tire base and the wheel tension band.

FIG. 7 is the view illustrating the electricity-generating wheel with hydraulic filled pouches generating electricity by driving the hydraulic driven alternator by using the pressure within the hydraulic filled pouches installed within the tire base or between the tire base and the wheel tension band.

FIG. 8 is the view illustrating the electricity-generating wheel in the dual hub alternator rail wheel and the rail.

FIG. 9 is the view illustrating the electricity-generating wheel with snow tires that melts ice and snow and also generates electricity by virtue of the resistance and hot air pouches installed to the tire base.

FIG. 10 is the view of the power plant with electricity-generating wheels having track, electricity-generating wheel, electric-driven tractor and electricity-generating wheeled trailer groups.

FIG. 11 is the view of the power plant with electricity-generating wheels having tele-wheel operating system that bears the electricity-generating wheel installed axle groups on a track floor.

FIG. 12 is the view of the power plant with electricity-generating wheels having chain conveyor operating system that generates electricity with electricity-generating wheeled axle groups activated by chain drive on grooved track.

The drawings are not necessarily drawn to be scaled and details not required for understanding the present invention may have been omitted. Furthermore, elements that are at least substantially identical or that have at least significantly identical functions are illustrated with the same numbers.

### DESCRIPTION OF THE PART REFERENCES

A. Wheeled power plant with renewable energy
1. Wheel
1.1. Tire
1.1.1. Tire base
1.2. Detachable rim
1.3. Wheel weight+vehicle weight per wheel
1.4. HB Thrust/Deformation Force
1.5. Points moving on the plane
1.5.1 Point H for touching the ground
1.5.2 Point B (deformation point in case of movement)
1.6 Wheel radius
1.7 Wheel rotation radius
2. Electricity-generating wheel
2.1 Generator wound dual hub motor-driven electricity-generating wheel with alternator
2.1.1 Brushless alternator
2.1.2 Drive shaft
2.1.3 Drive shaft fastening hook
2.1.4 Gear group
2.1.5 Generator wound hub motor
2.1.6 Stator
2.1.7 Coil
2.1.8 Ball bearing
2.1.9 Brushless rotor
2.1.10 Magnet
2.1.11 Common shaft rotating the rotors
2.1.12 Air/hydraulic filled pouch
2.1.13 Air/hydraulic transition channel
2.1.14 Collection case with air funnel
2.1.15 Rim assembly slot
2.1.16 Rim assembly slot cover
2.1.17 Air/hydraulic inlet-outlet ducts
2.1.18 Insulated electricity output terminals
2.1.19 Triggering band
2.1.20 Generator wound hub motor
2.2 Stationary generator wound stator hub motor-driven electricity-generating wheel
2.2.1 Circular rotor drive system
2.2.2 Ball roller channel
2.2.3 Ball roller
2.3 Gooseneck upright stationary electricity-generating wheel
2.3.1 Gooseneck bearing foot
2.3.2 Wheel nut
2.3.3 Pulley/drum
2.3.4 V. belt
2.3.5 Electrical motor
2.3.6 Platform
2.3.7 Rim rotor wheeled power plant
2.4 Piezo crystal electricity-generating wheel
2.4.1 Piezo crystal
2.4.2 Tire tension band
2.4.3 Piezo crystal electricity outputs
2.5 Hydraulic filled pouch electricity-generating wheel
2.6 Electricity generating iron wheel
2.6.1 Iron rail wheel
2.6.2 Constraining protrusion in the wheel
2.6.3 Rail
2.6.4 Wheel rail combination
2.6.5 Rail wheel drive shaft output hole
2.7 Snow tire electricity-generating wheel
2.7.1 Resistance
3. Track system wheeled power plant
3.1 Electric-driven tractor
3.2 Trailer (with electricity-generating tire)
3.3 Trailer groups
3.4 Track floor (with electric generators installed)
3.5 Overhead power transmission lines
3.6 Underground power transmission line
3.7 Accumulator groups
3.8 Hydraulic driven alternator
4. Wheeled electricity generating power plant with draglift carrier
4.1 Draglift system
4.2 Axle
4.3 Feet bearing the drums and the system
4.4 Rope (overhead line)
5. Platform wheeled power plant with chain and channel application
5.1 Track floor
5.2 Chain line
5.3 Chain operation channel
5.4 Axle traction foot

### DETAILED DESCRIPTION OF THE INVENTION

In this detailed description, preferred embodiments of the wheeled power plant with renewable energy (A) of the invention are explained only for better understanding of the subject and are not intended to be restrictive in any manner.

The invention relates to a novel type of wheeled power plant with renewable energy (A) wherein a plurality of the wheels generating electrical energy (2) more than the electrical energy required for rotation of at least one wheel that generate energy (2) are assembled together within a system and control, and generate energy in the order of MW by moving said wheels at desired speed by triggering also the electric generators installed on the ground on which said wheels (1) will travel, wherein generated electricity is provided with required technical specifications and values and transferred to an interconnected system.

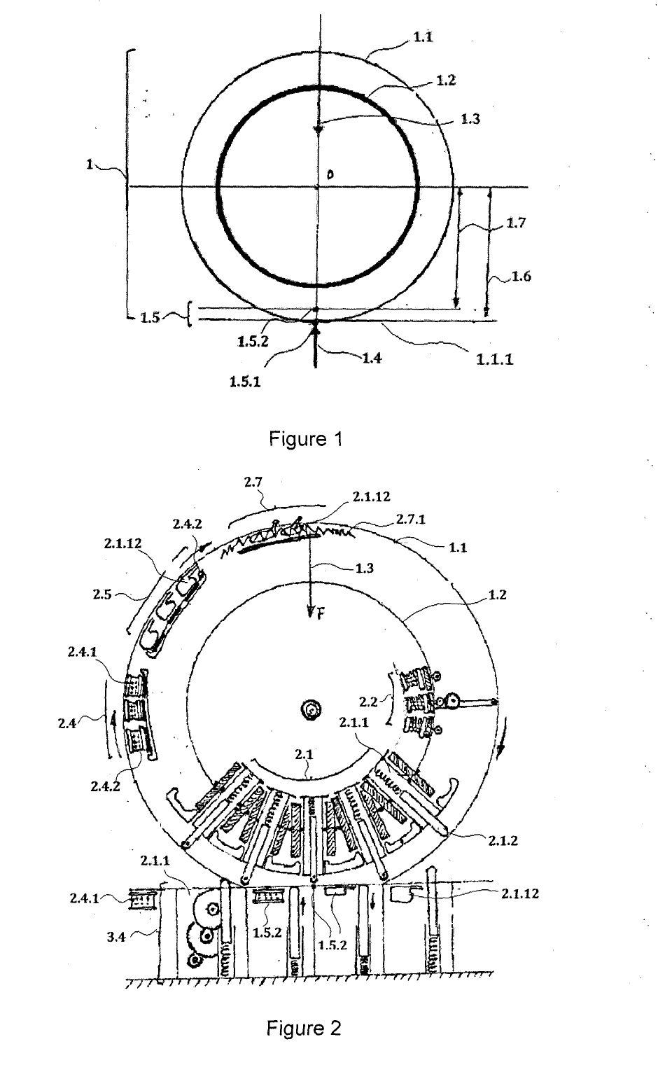

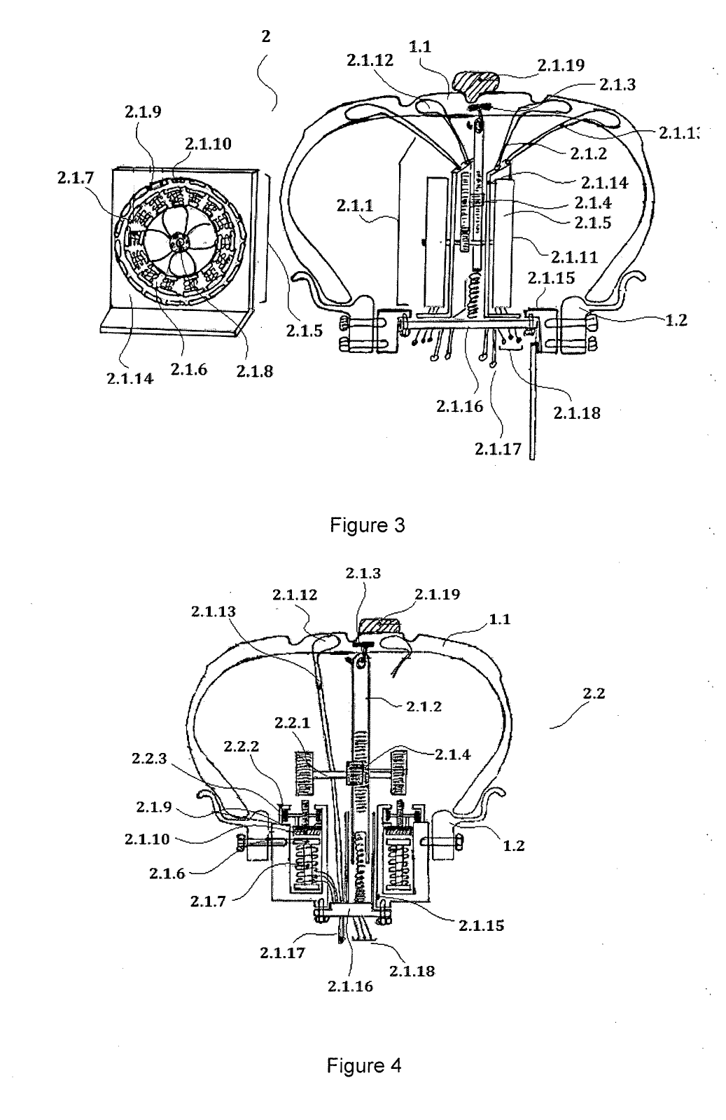

As illustrated in FIG. 1, the essential point of the wheeled power plant with renewable energy is the kinetic energy generated as a result of rotation of the wheel (1) and the deformation that occurs in the tire base (1.1.1) at the point H for touching the ground (1.5.1) of this wheel (1) while all kinds of vehicles fitted with said wheel (1) is in motion. As illustrated in FIG. 1, the tire base (1.1.1) becomes subject to deformation at the point H for touching the ground (1.5.1) where it touches the ground due to the wheel weight+vehicle weight per wheel (1.3) and collapses in the order of 1-2 cm and comes to point B (1.5.2). Said collapse can be increased by installing triggering band (2.1.19) to the tire base (1.1). In regard to the deformation formed by the HB Thrust/Deformation Force (1.4); after the point H for touching the ground (1.5.1) is released from the floor, it also escapes from the impact of the HB Thrust/Deformation Force (1.4) and the tire base (1.1.1) resumes its former round shape at the point H for touching the ground (1.5.1) as the deformation dislocates with the impact of the centrifugal force and due to the restitution property of the tire material of the tire base (1.1.1). Identical deformations occur at all points in the rotation direction along the periphery of the wheel (1) as the wheel (1) touches the ground and the deformation is improved after said touching the ground ends and said motion constantly occurs at all points along the periphery of the rotating wheel (1).

Due to these deformations, impacts that create collapses inward from the tire base (1.1.1) with the force generated by the weight in hundreds of kilograms in the order of split seconds depending on the rotation speed of the wheel (1) are formed, wherein these impacts operate the gear groups (2.1.4) of the drive shafts (2.1.2) (such as crank, lever, piston, leverage, etc.) connected to the drive shaft fastening hooks (2.1.3) embedded in tire base (1.1.1) and the value of these impacts are adjusted as desired and used for activation of at least one brushless alternator (2.1.1) and electrical generators installed between or outside the tire base (1.1.1) and the rim assembly slot (2.1.16) detachable rim (1.2) thus forming the electricity-generating wheel (2) that generates AC/DC electricity. Said manufactured electricity-generating wheels (2) are used in the electric-driven vehicles, rail systems and wheeled power plants with renewable energy (A). First of all, the electricity required for rotation of the wheels (1) is used for operating the system from the electricity generated by bringing together at least one or more of these electricity-generating wheels (2) designed and developed for generating electricity more than the electrical energy required for rotation of the electricity-generating wheel (2), and the surplus electricity will be transferred to the interconnected system after providing thereof with suitable technical specifications and values, thus realizing wheeled power plant with renewable energy (A). The designs developed for the electricity-generating wheel (2), which is the essential element of said wheeled power plant with renewable energy (A) and solutions related to the wheeled power plant with renewable energy formed using these designs are as listed below.

brushless alternator (2.1.1) that comprises brushless rotor (2.1.9) and fixed stator (2.1.6) between the wheel (1) tire base (1.1.1) and at least one detachable rim (1.2) bottom. Stators (2.1.6) with ball bearing (2.1.8) installed in the center thereof are fixed on the two collection cases with air funnel (2.1.14) fixed on at least one assembly slot cover (2.1.16), and the brushless rotors (2.1.9) are fixed to the ends of the common shaft rotating the rotors (2.1.11) passing through the ball bearing (2.1.8). A small gear is installed on the common shaft rotating the rotors (2.1.11) to which the brushless rotors (2.1.9) are fixed; brushless alternator (2.1.1) which will enable operation with various mechanisms, drive shaft (2.1.2) that will receive the H Thrust/Deformation force (1.4) to activate the system from the tire base (1.1.1) and gear groups (2.1.4) for rotating this gear are installed between the collection casings.

In order to enable easy installation of said brushless alternator (2.1.1) group between the tire base (1.1.1) interior and the detachable rim (1.2), rim assembly slots (2.1.15) equal to the number of the alternator groups to be used will be established in the detachable rim (1.2) bottom in order to facilitate the assembly. Airtight insulated electricity output terminals (2.1.18) and air/hydraulic inlet-outlet ducts (2.1.17) are applied together on the assembly slot cover (2.1.16). The system will be cooled naturally with the contact of the detachable rim (1.2) body with the outdoor air during rotation as well as with the cold air that flows in and out from outdoor by compacting and releasing air filled pouches (2.1.12) with the HB Thrust/deformation Force (1.4). AC/DC electricity will be generated with the help of the wheel tire (1.1) with triggering band (2.1.19) and air/hydraulic filled pouch (2.1.12) to be manufactured with size and properties fit for purpose and numerous dual hub motor-driven alternators (2.1) and electrical generator groups to be installed between the detachable rim (1.2) suitable for this wheel as illustrated in FIG. 2 and the generated electricity will be either stored or directly used in electric-driven vehicles after provided with desired technical values and specifications by passing through required intermediate operations. By rotating thousands of electricity-generating wheels (2.1) at certain speed within a system, a wheeled power plant with renewable energy (A) capable of generating electricity in the order of MW with a quality that can be transferred to interconnected system is implemented.

As illustrated in FIG. 4, the design of the stationary generator wound stator hub motor-driven electricity-generating wheel (2.2) is as follows; at least one row of fixed stator coils (2.1.7) are installed within wheel (1) tire base (1.1.1) and deepened bottom of at least one rim assembly slot (2.1.15) and at least one detachable rim (1.2) and the circular rotor drive system (2.2.1) comprising ball rollers (2.2.3) and ball roller channels (2.2.2), in which required number of magnets (2.1.10) are installed in such manner not to exceed the height of the rim sidewall, is installed over the same. The mechanism comprising the drive shaft (2.1.2) and the gear group that will receive the HB Thrust/deformation force (1.4) generated in the tire base (1.1.1) thus enabling the circular rotor drive system (2.2.1) to rotate, is easily installed within the detachable rim (1.2) at certain intervals by virtue of the rim assembly slot (2.1.15) and assembly slot cover (2.1.15) thus enabling rotation of the system in every deformation. The assembly slot cover (2.1.16) is easily-fit into the assembly slots (2.1.15) established in the detachable rim bottom (1.2) thus enabling fast rotation of the roller and rail rotor mechanism in every deformation in the tire base (1.1.1). The speed of the circular rotor system is adjusted as a result of adjustment of the gear groups (2.1.4) thus obtaining AC/DC current in the order of KW, thus obtaining a novel generator wound hub motor type electricity-generating wheel (2.2). As is the case in the classical wheel rims, the opening on the detachable rim (1.2) body does not prevent installation of brake lining mechanisms, thus the invention can be used in both old and new vehicles. The electricity generated in the stationary generator wound stator hub motor-driven electricity-generating wheel (2.2) is outputted through insulated terminals on the rim assembly slot cover (2.1.16). In regard to cooling of the system, the air/hydraulic filled pouches (2.1.12) are cooled by means of the air flowing in and out from the air outlet ducts (2.1.17) on the assembly cover (2.1.16), as well as cooling the aluminum body with the contact of air at the time of rotation. This design also generates electricity more than the electricity required for rotation of the stationary generator wound stator hub motor-driven electricity-generating wheel (2.2), thus realizing wheeled power plant with renewable energy (A) wherein surplus electricity generated in the order of MW, GW generated by bringing together thousands of stationary generator wound stator hub motor-driven electricity-generating wheels (2.2) can be provided with the desired technical specifications and values and can be transferred to the interconnected system.

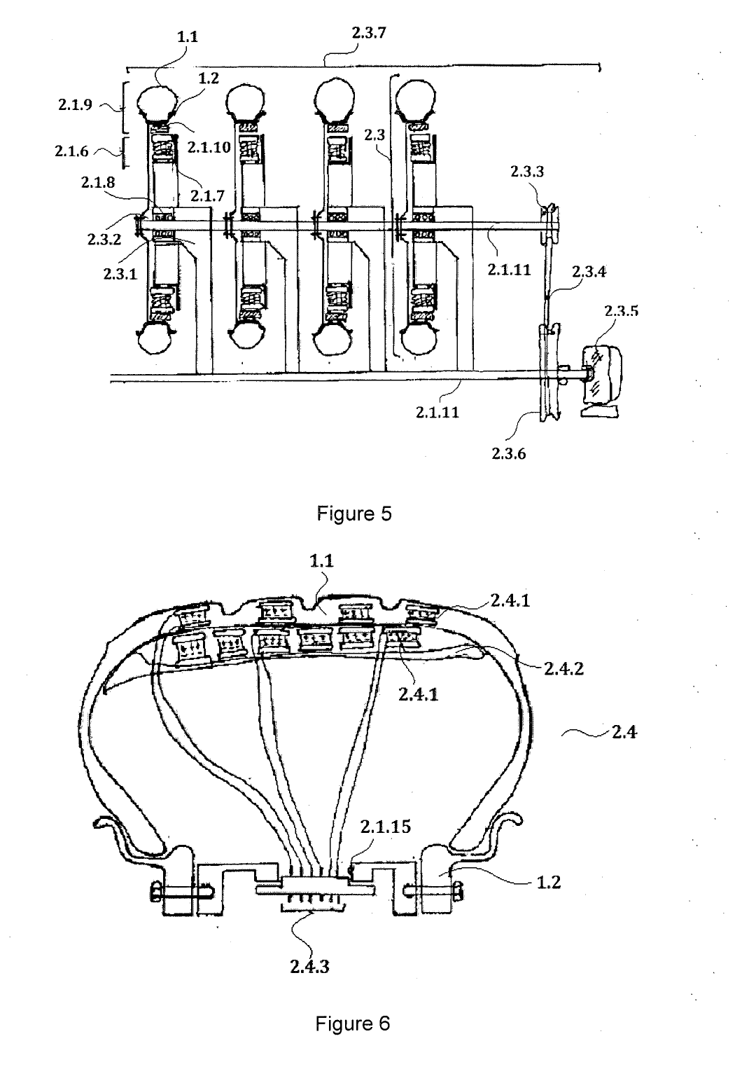

As illustrated in FIG. 5, the design of stationary electricity-generating wheel (2.3) in the gooseneck bearing foot (2.3.1) is as follows; the stator (2.1.6) made with the generator wound coils (2.1.7) installed on the circular bearing, is fixed on the gooseneck foot (2.3.1). Wheel (1) functions as brushless rotor (2.1.9) with the magnets (2.1.10) circularly installed on the wheel (1) detachable rim (1.2) bottom. The wheel (1) functioning as brushless rotor (2.1.9) fixed to the free rotating shaft (2.1.11) within the ball bearing (2.1.8) disposed in the fixed stator (2.1.6) and gooseneck foot (2.3.1) rotates fastly around the stator (2.1.6) fixed to the gooseneck foot (2.3.1) and generates electricity in the order of KW, thus obtaining electricity generating wheel (2.3) with generator wound hub motor alternator. Numerous gooseneck feet (2.3.1) arranged on the platform (2.3.6) and the stators (2.1.6) fixed thereto and ball bearings (2.1.8) placed on identical points on the gooseneck feet (2.3.1) and the brushless rotors (2.1.9) fixed to the common shaft (2.1.11) passing through the center of the same and the electrical motor (2.3.5) are rotated at a constant speed with the V belt (2.3.4) thus generating clean AC/DC electricity in the order of MW with desired technical specifications and values. A novel type of wheeled power plant with renewable energy (A) generating electricity in the order of GW with desired technical specifications and values is constructed with the generation group obtained by installing many platforms (2.3.6) of these electricity generating platforms (2.3.6) in collateral and superimposed position. It is further possible to achieve the same result by operating the generator wound hub motor type electrical generator containing electricity-generating wheel (2.3), brushless rotor (2.1.9) and stator (2.1.6) in reverse manner, that is to say where stator (2.1.6) is active at the rim (1.2), and also by operating brushless rotor (2.1.9) on the stationary bearing body. As is the case with other systems, the generation in the wheeled power plants with renewable energy (A) is initiated by supplying the initial power to the electrical motors (2.3.5) from interconnected system or from the charged accumulators (3.7) incorporated to the system. The accumulators (2.3.7) are recharged with the first electrical energy generated, then the electrical motors (2.3.5) are fed and the surplus electricity generated more than the required by the electrical motors (2.3.5) are supplied to the interconnected system.

As illustrated in FIG. 6, design of the piezo crystal electricity-generating wheel (2.4) is as follows; the HB Thrust/Deformation Force (1.4) that occurs in the rotating wheel (1) at the point H for touching the ground (1.5.1), where the wheel (1) touches the ground, crushes the piezo crystals (2.4.1) installed between interior of the wheel (1) tire base (1.1.1) and tire tension band (2.4.2) or directly into the tire base (1.1.1) material with HB Thrust/Deformation Force (1.4) under pressure, thus generating AC/DC electricity. Piezo crystals (2.4.1) are compressed and crushed at the point H for touching the ground (1.5.1), where the wheel (1) touches the ground, with the HB Thrust/Deformation Force (1.4) and generate electricity. When the piezo crystal (2.4.1) at the point H (1.5.1) is free from the ground, as the tire base (1.1.1) is released from deformation and reassumes its shape due to the nature of the tire (1.1), the piezo crystal (2.4.1) will return to its former condition as well. Hundreds of piezo crystal (2.4.1) to be installed around the periphery of the tire base (1.1.1) in a circular fashion and with the width of the tire base (1.1.1) will continue to generate AC/DC electricity as long as the wheel (1) continues to rotate. Generated electricity is stored and outputted as is the case in other systems and are accumulated in accumulators (3.7). A piezo crystal electricity-generating wheel (2.4) which can also be used in electric-driven vehicles is obtained with these pressurized piezo crystals (2.4.1). A novel type of wheeled power plant with renewable energy (A) is implemented by arranging these electricity-generating wheels (2) on a suitable platform (2.3.6) collaterally and by increasing the number of said platforms (2.3.6), which is capable of providing the electricity accumulated in the accumulators (3.7) with the required technical specifications and values and transferring the same to the interconnected system at MW values.

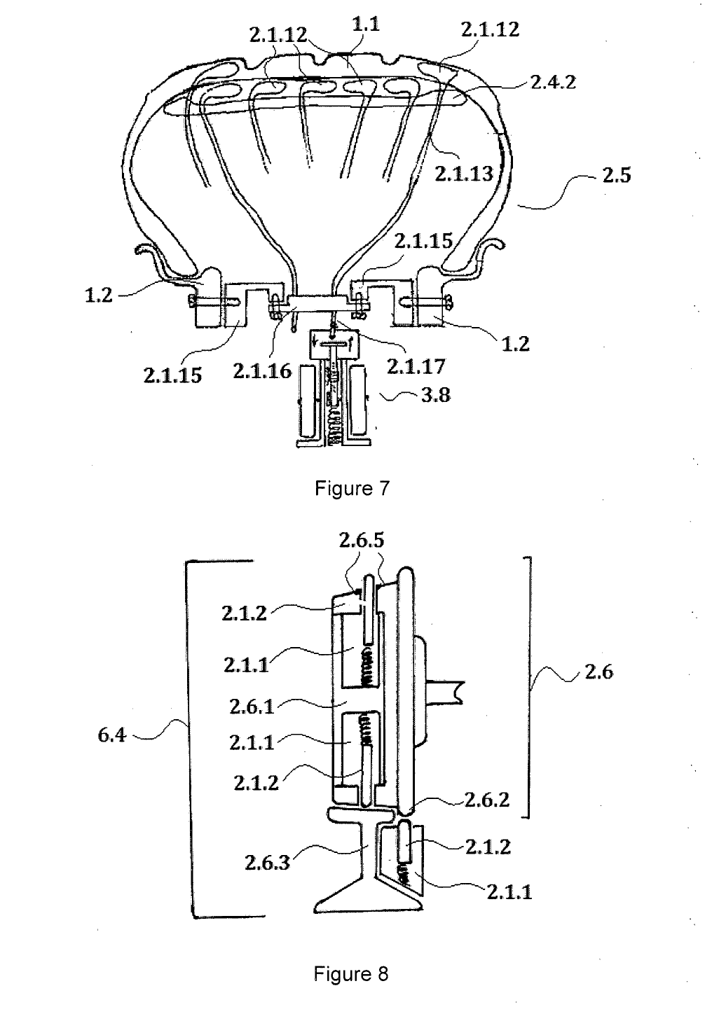

As illustrated in FIG. 7, the design of the hydraulic filled pouch electricity-generating wheel (2.5) is as follows; the HB Thrust/Deformation Force (1.4) that occurs in the rotating wheel (1) at the point H for touching the ground (1.5.1), where the wheel (1) touches the ground, crushes the air/hydraulic filled pouches (2.1.12) installed between interior of the wheel (1) tire base (1.1.1) and tire tension band (2.4.2) or directly into the tire base (1.1.1) material with the pressure applied by HB Thrust/Deformation Force (1.4) and generates AC/DC electricity by operating alternator, generator, dynamo, hub motor and various other electrical generators disposed on the detachable rim (1.2) or a suitable platform with the help of gear groups (2.1.4) after some intermediate processes by exhausting the air by means of pressure from air/hydraulic ducts (2.1.12) and air/hydraulic outlet ducts (2.1.17) disposed on at least one assembly slot (2.1.15) established on the detachable rim (1.2) bottom and assembly slot cover (2.1.16) for covering thereof, wherein such method also produces hydraulic filled pouch electricity-generating wheel (2.5) and said wheels can also be used in electric-driven vehicles. Elastic air/hydraulic filled pouches (2.1.12) become compressed and crushed at the point H for touching the ground (1.5.1), where the wheel (1) touches the ground, and the hydraulic material is ejected under same pressure; when the air/hydraulic filled pouches (2.1.12) at this point are free from the ground, as the tire base (1.1.1) is released from deformation and reassumes its shape due to the nature of the tire, the air/hydraulic filled pouches (2.1.12) will resume their original form and suck the ejected hydraulic. Hundreds of air/hydraulic filled pouches (2.1.12) to be installed around the periphery of the tire base (1.1.1) in a circular fashion and with the width of the tire base (1.1.1) will continue to generate more pressure and more AC/DC electricity as long as the wheel (1) continues to rotate. It is possible to generate electricity in the order of MW by operating numerous generators installed on the trailer (3.2) through required apparatus and gear groups (2.1.14) with the pressure in the wheels by installing hydraulic filled pouch electricity-generating wheels (2.5) instead of trailer wheels, as is the case in the track solution using more pressure, more electrical generators or in the track solution where these generators will be installed. After providing AC/DC electricity generated by increasing the number of trailers (3.2) and towing thereof in an order with the desired technical specifications and values, a novel type of wheeled power plant with renewable energy (A) is implemented capable of transferring electricity in the order of MW-GW to the interconnected system.

FIG. 8, the design made for generating electricity in rail systems such as trains, metro, tramway is as follows; the AC/DC electricity generating iron-tire electricity-generating wheel (2.6) is obtained by applying drive-shaft brushless alternator (2.1.1), generator, dynamo, hub motor and similar power sources to the iron train wheels (2.6.1) in rail vehicles. AC/DC electricity is generated as at least one drive-shaft brushless alternator (2.1.1) installed on the iron rail wheel (2.6.1) swiftly pushes inward the drive shaft (2.1.2) protruding from the rail wheel drive shaft output hole (2.6.5) established on the iron rail wheel (2.6.1) bottom with the HB Thrust/Deformation Force (1.4) generated at the Point H for touching the ground (1.5.1) where the iron wheel (2.6.1) touches the ground and rotates brushless rotors (2.1.9) fastly by means of mechanisms and gear groups (2.1.4). After point H for touching the ground (1.5.1) is free from the rail (2.6.3), the drive shaft (2.1.2) is returned to original position by means of a spring and the drive shafts (2.1.2) of other brushless alternators (2.1.1) on the iron rail wheel (2.6.1) repeat the same motion constantly along the way. A train that generates electricity is obtained by replacing all old wheels of the locomotive and coaches of the train with iron-tire electricity-generating wheel (2.6). Generated electricity is provided with the desired technical specifications and values and surplus energy to be generated along the way is transferred to the interconnected system through the overhead line the train uses. It is possible to generate electricity in the order of MW and transfer the same to the interconnected system by employing this method which is applied to the train wheels to the rail edges along the way. The drive shaft (2.1.2) of the single drive-shaft brushless alternator (2.1.1) with spring installed to the rails is pushed by the constraining protrusion in the wheel (2.6.2) at the edge of the iron train wheel (2.6.1) and the brushless rotors (2.1.9) are rotated fast in the alternator and the system continues to generate AC/DC electricity continuously along the way. In this method, first the requirement of the locomotive is supplied from the electricity generated by the electric locomotive driven by the power supplied from the interconnected system and coaches with increased number of electricity-generating wheels (2.6), and the remaining electricity and electricity generated from the rails is transferred to the interconnected system, thus obtaining a novel wheeled power plant. With this method, continuously operated trains, tramways and metros are converted into actual wheeled power plants with renewable energy (A).

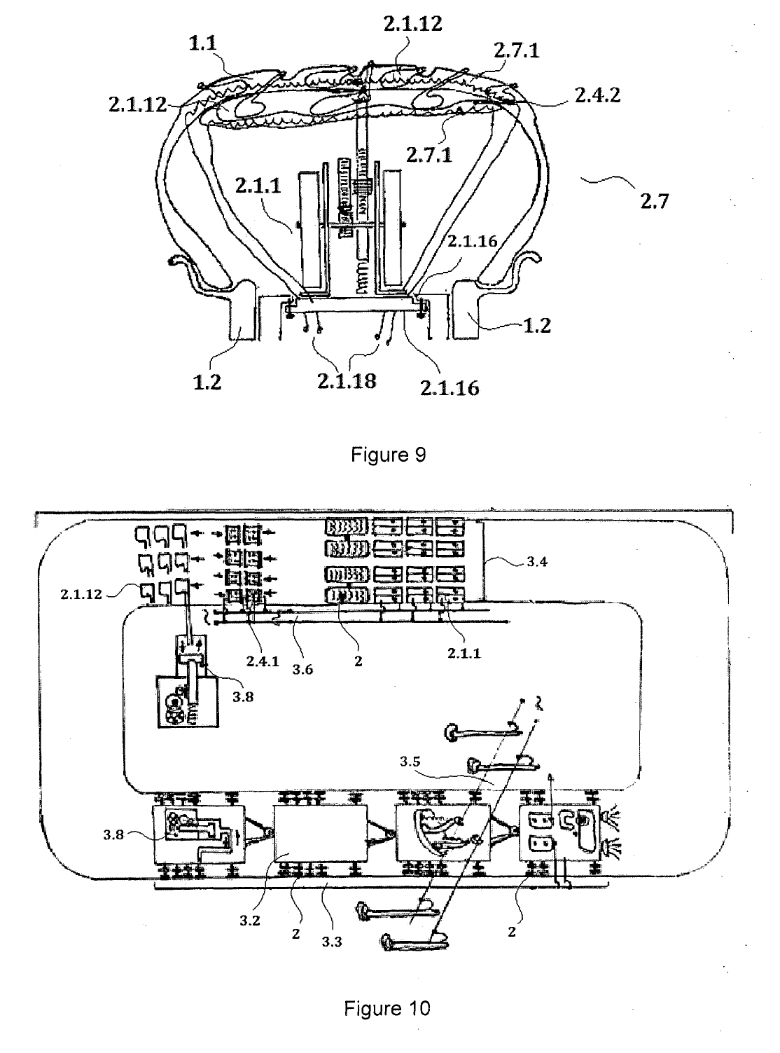

As illustrated in FIG. 9, the design of the snow tire electricity-generating wheel (2.7) is as follows; air/hydraulic filled pouches (2.1.12) and resistances (2.7.1) are installed between interior of the wheel (1) tire base (1.1.1) and tire tension band (2.4.2) or directly into the tire base (1.1.1) material. Air/hydraulic inlet-outlet ducts (2.1.17) of said air/hydraulic filled pouches (2.1.12) are installed toward the outside of the tire (1.1) and in a manner that the mouth thereof will be open. Resistances (2.7.1) are homogenously placed within the tire base (1.1.1), more intensified in the zones containing air/hydraulic filled pouches (2.1.12). Resistances (2.7.1) heated electrically during snow and icy weather conditions rapidly heat both the tire base (1.1.1) and the air inside the air/hydraulic filled pouches (2.1.12) and rapidly discharges the hot air inside the air/hydraulic filled pouches with the HB Thrust/Deformation Force (1.4) generated at the Point H for touching the ground (1.5.1), where the wheel (1) touches the ground, and repels and cleans, thus provides safe driving opportunity, the snow and ice on the ground and on the tire base (1.1.1) with the impact of the heated tire and hot air. When point H for touching the ground (1.5.1) is free from the ground, crushed and discharged air pouch is refilled with air as the HB Thrust/Deformation Force (1.4) is removed and due to the tendency of the tire material to return to its original form and becomes subject to shock heating until the next instant of touching the ground. Other air pouches (2.1.12) in the rotation direction of the wheel continuously perform the same processes and ensure continuity of the event, thus maintain safe driving. Snow tires with resistance and hot air pouches (2.7) can be easily used in vehicles with outdated technology and electric-driven vehicles by installing accumulator groups (3.7). This type of snow tire with heater (2.7) can also be implemented in all electricity-generating wheels (2) and classical tire wheels.

As illustrated in FIG. 10, for track solution, the electric-driven tractor (3.1) with numerous electricity-generating wheels (2) is the system that will generate AC/DC electricity from electricity-generating wheels (2) and also from extra electrical generators installed at the track floor (3.4) in a long and closed track with sweep turns constructed in such manner to enable travel at planned constant speed for the electricity generating vehicle group comprising the trailer (3.2), trailer groups (3.3) and rolling stocks formed by such groups, and transfer the same to the interconnected system by means of overhead transmission lines (3.5) or underground transmission lines (3.6) after provided with the desired technical specifications and values. Electric-driven tractors (3.1) supply their electrical need for initial motion and until reaching to the speed where electricity generation process will start from previously charged accumulator groups (3.7) or directly from the interconnected system. After electricity generation process is initiated, electric-driven tractors (3.1) cut-off the electricity exchange and continue to feed from the power generated by the system and surplus electricity is transferred to the interconnected system. System continuously running on the constant speed means that the sinus curves and technical values of the generated electricity have identical quality. The installation capacity and the amount of electrical power generated will increase when the number of the electricity generating trailer groups (3.3) is increased and the order of MW-GW will be achieved. A novel environmentally friendly type of renewable energy is generated as the kinetic energy generated from rotational motion of the wheel converts by activating the magnetic energy into electrical energy, which is called as wheeled power plant (3) with track solution. Extra AC/DC electrical energy in addition to the track solution is generated by means of the pressure created by the wheel weights of the trailer groups (3.3) constantly in motion with the intermediate mechanism of the brushless alternators (2.1.1), hub motors, generators, dynamos, natural magnet coil generators, piezo crystals (2.4.1), hydraulic filled pouch (2.1.12) hydraulic driven alternator (3.8) and similar other electrical generators installed within the track floor (3.4) constantly engaged by the electricity-generating wheels (2) of the electric-driven tractor (3.1) and trailer groups (3.3) moving on a certain line on the track (3.4) at a constant speed, which is transferred to the interconnected system through underground transmission lines (3.6) after provided with the desired technical specifications and values. If desired, tractors running on fossil, biochemical, chemical, hydrogen fuels and solar panels can also be used instead of electric-driven tractor (3.1) in the same track solution. In the track floor (3.4) solution, on the other hand, power generation can be achieved by using classical wheels that do not generate electricity as the wheels (1) of the tractor (3.1) and the trailers (3.2). The method of track floor with electric generators installed (3.4) can also be applied to the roads with intensive vehicle and pedestrian traffic and the electricity to be thus generated can be either stored in the accumulator groups (3.7) or transferred to the interconnected system without storage after provided with the desired technical specifications and values.

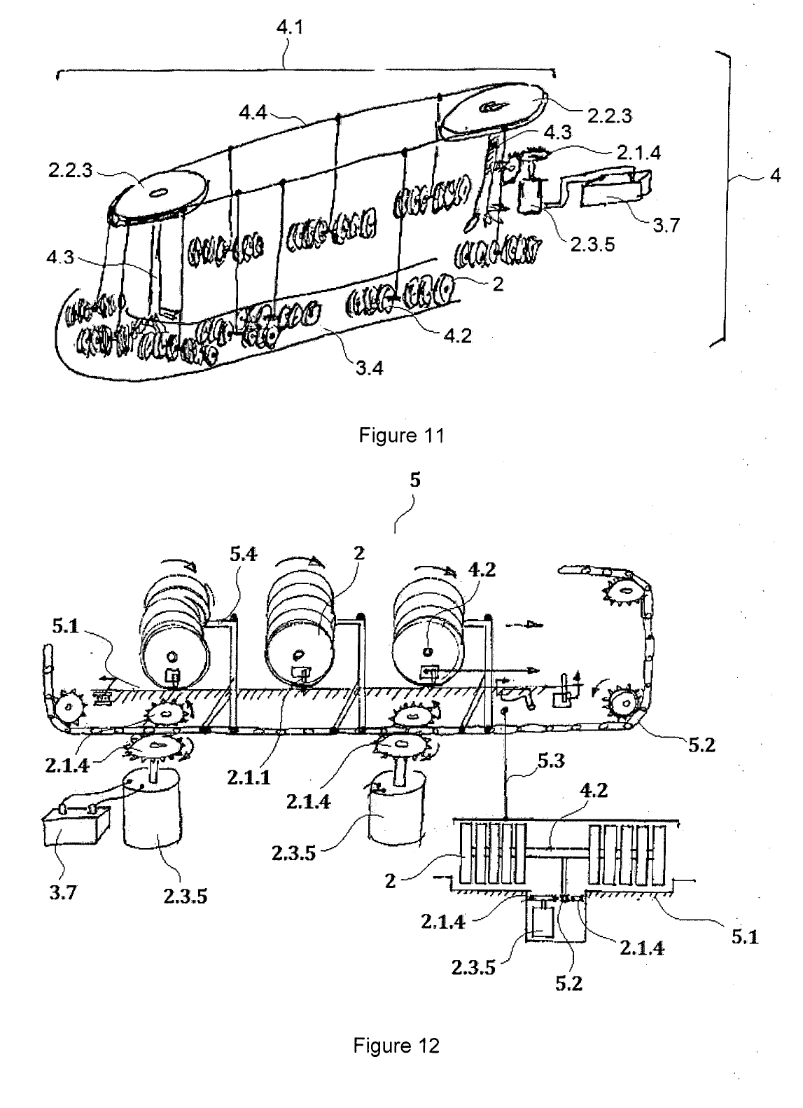

As illustrated in FIG. 11, as is the case for chairlift and ropeway facility, using an axle (4.2) with numerous electricity-generating wheels (2) installed and at least two of said axles (4.2), the first drum (2.3.3) out of two drums used and installed on the feet bearing the system (4.3) is used for tensioning the rope (4.4) while the second drum (2.3.3) is used for rotating the rope (4.4) at desired speed through reinforced electrical motor (2.3.5) drive by virtue of the gear group (2.1.4).

The electricity-generating wheels (2) installed on the axles (4.2) connected to the rope (4.4) moving under tension apply all their weight to the track floor (5.1) and continue to circuit at constant speed and on a constant route. When the electricity-generating wheels (2) installed on the axles (4.2) perform free rotation, they continue to generate AC/DC electricity with the impact of the wheel weight+vehicle weight per wheel (1.3) and HB Thrust/Deformation Force (1.4). As in the track system, an additional line that generates AC/DC electricity is formed by installing brushless alternator (2.1.1) driven by the weight of the wheels (1), piezo crystal (2.4.1), hydraulic filled pouch (2.1.12), alternator, generator and dynamo type electricity generating generators within the track floor with electric generators installed (3.4) on which electricity-generating wheels (2) circuit in the draglift system (4.1).

In the draglift system (4.1), the electrical motors (2.3.5) that will drive the system draws the initial power required either from the interconnected system or from the accumulator groups (3.7) charged as a substitute and the electrical motors (2.3.5) continue to be fed from the electricity generated by the electricity-generating wheels (2) installed on the axles (4.2) at a certain speed and the electricity generated by the system after providing the AC/DC electricity generated by the generators installed on track floor with electric generators installed (3.4), with the desired technical specifications and values; surplus electricity is then transferred to the interconnected system through spin ropes (4.4) used as overhead line and the electricity generated from the track floor with electric generators installed (3.4) is also transferred to the interconnected system through underground transmission lines (3.6). This operating system constitutes the wheeled electricity generating power plant with draglift carrier (4).

As illustrated in FIG. 12, an axle (4.2) with numerous electricity-generating wheels (2) installed and at least one of these axles (4.2) pulls serially the axle traction feet (5.4) fixed to the chain (5.2) by means of the chain line (5.2) installed in the chain operation channel (5.3) at the center of the track floor (5.1) and the electrical motors (2.3.5) and close gear groups (2.1.4) that will move the chain line (5.2).

The electricity-generating wheels (2) rotating in connection with the axles (4.2) generate electricity by means of wheel weight+vehicle weight per wheel (1.3) and HB Thrust/Deformation Force (1.4), and also by means of wheel weight+vehicle weight per wheel (1.3) at least one dual hub motor-driven alternator (2.1), piezo crystal (2.4.1), hydraulic filled pouch (2.1.12), generator and electrical generators installed to the track floor (5.1) starts to generate AC/DC electricity. For this generation, the electrical motors (2.3.5) in the system draw initial power by being fed from charged accumulators (3.7) or from the interconnected system. After efficient generation process is initiated, the system first recharges the accumulators (3.7) and then draws the electrical energy required by the system and then the surplus energy is transferred to the interconnected system after provided with the desired technical specifications and values, thus achieving a chain bearing system wheeled power plant (5) with renewable energy.

1-29. (canceled)

30. A wheeled power plant with renewable energy, comprising at least one electricity-generating wheel (turbine in the form of a wheel) that comprises:
drive shafts providing the conversion of the elastic change of shapes (collapse and push) created at the points where the tire touches the ground due to the continuous collapse of the points of the tire touching the ground during the movement of the vehicle, with the influence of the vertical forces on the vehicle wheel, into the mechanical action;
gear group converting the vertical motion of the drive shafts into rotational motion and providing the increase of the cycle of the motion created;
at least one brushless alternator converting the rotational motion for which the cycle is increased by the gear group, into the electrical energy;
brushless rotor and fixed stator forming the brushless alternator;
a detachable rim providing access to the inner gap of the tire and therefore enabling the placement of the mentioned brushless alternator, gear group, drive shafts and similar parts within the inner gap of the tire without any need for full separation of the rim and the tire.

31. A wheeled power plant with renewable energy, comprising:
at least one trailer or a trailer group with at least one electricity-generating wheel providing the generation of energy from the movement of elastic deformation forming at the points where the vehicle tire touches the ground;
a track on which the mentioned trailer or the trailer group travels continuously at a determined speed, in order to enable continuous generation of electricity from the electricity generating wheels;
electric-driven tractor providing the movement of the trailer or the trailer group;
chargeable accumulator groups or interconnected system providing the initial energy required for the electric-driven tractor for starting the trailer or the trailer group travelling continuously on the track;
underground or overhead (aerial) power transmission lines providing the electricity energy acquired from the trailer or the trailer group travelling continuously on the track, to be transmitted to the electric-driven tractor and/or interconnected system and/or storage and/or where it is to be used.

32. The wheeled power plant of claim 31, further comprising a track floor with drive shafts and/or hydraulic filled pouches and/or piezo crystals and similar electric generators.

33. A wheeled power plant with renewable energy configured to perform an electricity generation cycle formation method comprising:
the electric driven tractor pulling the trailer or the trailer groups with electricity generating wheels, starting to move on the track by taking the initial energy from the accumulator groups or the interconnected system;
formation of HB thrust/deformation force due to the wheel weight+vehicle weight per wheel on the tire base of the electricity generating wheels;
collapse of the point H for touching the ground where the tire touches the track floor with the effect of HB thrust/deformation force and reaching point B;
vertical motion of the drive shaft due to the elastic deformation on the tire base;
conversion of the vertical motion of the drive shaft into the rotational motion at the gear group;
increase of the number of cycles of the motion received from the drive shaft, at the gear group;
rotation of the brushless rotor with high speed around the fixed stator with the effect of the high speed rotational motion transferred from the gear group;
generation of electricity energy at the brushless alternator with the rotation of the brushless rotor around the fixed stator;
transfer of the electricity energy acquired from the electricity generating wheels to the interconnected system and/or electric driven tractor and/or accumulator groups by means of underground or overhead power transmission lines;
continuous travel of the trailer or trailer groups on the track and maintaining the electricity generation cycle.

34. The wheeled power plant of claim 33, wherein the electricity generation cycle formation method further comprises:
the trailer or the trailer group with the electricity generating wheels travelling on the track floor equipped with drive shafts and/or hydraulic filled pouches and/or piezo crystals and similar electricity generators;
generation of electricity energy from the electricity generators on the track floor during the passage of the trailer or the trailer group;
transfer of the electricity energy acquired from the electricity generators on the track floor to the interconnected system and/or electric driven tractor and/or accumulator groups by means of underground or overhead power transmission lines.

35. The wheeled power plant of claim 30, further comprising drive shafts and/or crank and/or lever and/or leverage on the electricity generating wheel, providing the conversion of HB thrust/deformation force into mechanical motion.

36. The wheeled power plant of claim 30, wherein the electricity generating wheel contains drive shaft—brushless alternator mechanism and/or piezo crystals and/or air/hydraulic filled pouches as electricity generator.

37. The wheeled power plant of claim 30, further comprising resistances on the electricity generating wheels, placed at the inner surface of the tire and providing the operation of the electricity generating wheels with the electricity it generates, and heating the tire base, thus enabling a safe drive on snowy, wet and icy grounds.

38. The wheeled power plant of claim 30, wherein the resistances placed on the inner surface of the tire heat the air and hydraulic fluid in the air/hydraulic filled pouches on the electricity generating wheel.

39. The wheeled power plant of claim 30, comprising:
a fixed stator on the detachable rim; and
electricity generating wheel in the form of alternator composed of brushless rotor providing a rotational motion and this way, generating electricity by means of the rail or ball roller channel on the detachable rim with the fixed stator.

40. The wheeled power plant of claim 30, comprising at least one electricity generating wheel with at least one gooseneck bearing foot providing the rotation of the brushless rotor around the fixed stator composed of coils placed in a circular bearing.

41. The wheeled power plant of claim 30, comprising:
at least electricity generating iron wheel with drive shafts and brushless alternator and
electricity generating rail system with drive shafts and brushless alternator providing the electricity generating iron wheels to be used as a continuous source of electricity.

42. The wheeled power plant of claim 30, comprising wheeled power plant with chain and channel application that comprises:
at least one axle pulled by a chain line driven by an electrical motor and/or pulley;
at least one electricity generating wheel attached on the axle;
electricity generating wheel;
channeled track on which the electricity generating wheel moves.

43. The wheeled power plant of claim 31, comprising at least one electrical motor and/or fossil fuel motor to drive the chain line used to pull the mentioned axles for the electricity generating wheels rotating as attached to the axles to generate electricity with the effect of the wheel weight+vehicle weight per wheel and HB thrust/deformation force in the wheeled power plant with chain and channel application.

44. The wheeled power plant of claim 31, comprising a wheeled electricity generating power plant with draglift carrier comprising:
at least one axle with electricity generating wheels;
rope to which the mentioned axles are connected by a draglift system
two drums providing the mentioned rope to stay as stretched from both sides and to rotate;
electrical motor enabling the rotation of the rope by providing the rotation motion of the drums and this way, giving the initial motion and/or continuation motion to electricity generating wheels attached on the axles connected to the rope by draglift system in order to generate electricity.
